(19) United States
(12) Patent Application Publication
(10) Pub. No.: US 2008/0276252 A1
(43) Pub. Date: Nov. 6, 2008

(54) KERNEL EVENT VISUALIZATION

(75) Inventors: Steve Pronovost, Redmond, WA (US); Ameet Chitre, Duvall, WA (US); Matthew David Fisher, Charlotte, NC (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/744,744

(22) Filed: May 4, 2007

(51) Int. Cl. G06F 9/46; G06F 15/00

(52) U.S. Cl. 719/318

(57) ABSTRACT

A visualization system may receive first data indicating a first occurrence of a first event. The first event may be associated with a first kernel at a first time. The second event may relate to a processor operation, a memory operation, a disk operation, and the like. The visualization system may receive second data indicating a second occurrence of a second event. The second event may be associated with a second kernel at a second time. The second event may relate to an operation of the second kernel. The first kernel may correspond to a central processing unit, and the second kernel may correspond to a graphic processing unit. The visualization system may provide, based on the first and second data, a human-perceptible representation of the duration between the first time and the second time. The visualization system may provide a timeline that represents the first data and the second data.

### BACKGROUND

Typically, graphics intensive computer applications such as gaming, digital media, high definition graphical user interfaces, and the like push the limits of a computer system's performance. The timely processing of graphics operations may require a complex interaction between the computer's central processing unit (CPU) and the computer's graphics processing unit (GPU). Because of the variability of computer hardware and software profiles, this interaction may not be accurately modeled or considered when designing the computer applications.

Generally, a well-designed system may load either the CPU or GPU at nearly 100%. Where both the CPU and the GPU operate at less than 100%, there may be additional, unrealized system performance. Processing capacity may relate to memory availability and processor availability, and these performance characteristics may be directly impacted by a memory management subsystem, a scheduling subsystem, and their interaction with the processor.

Traditional debuggers and performance tuners may address individual components and subsystems, such as CPU performance and GPU performance separately. For dedicated systems or less-processing intensive applications, such tools may be adequate; however, as graphical computer systems become more complex and as software applications increasingly push the limits of computer hardware, traditional tools may fail to diagnose the performance bottlenecks related to the interaction between the CPU and GPU.

Thus, there is a need for a system-level computer graphics performance tool that addresses the interaction among system components.

### SUMMARY

A visualization system may receive first data indicating a first occurrence of a first event. The first event may be associated with a first kernel at a first time. The first event may relate to a processor operation, a memory operation, a disk operation, and the like. The visualization system may receive second data indicating a second occurrence of a second event. The second event may be associated with a second kernel at a second time. The second event may relate to an operation of the second kernel. The first kernel may correspond to a central processing unit, and the second kernel may correspond to a graphic processing unit.

The visualization system may provide, based on the first and second data, a human-perceptible representation of the duration between the first time and the second time. For example, the visualization system may provide a timeline that represents the first data and the second data.

The visualization system may provide other information as well. For example, the visualization system may also provide a graph. The graph may represent a queue corresponding to the second kernel. The visualization system may include, as part of the human-perceptible representation, third data indicative of a vertical synchronization interval. The visualization system may identify a serialization of processing between the first kernel and the second kernel.

The visualization system may include an event processor and a display module. The event processor may receive the first and second data. The display module may provide the human-perceptible representation, based on the first and second data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts an exemplary operating environment;

FIG. 2 depicts an exemplary visualization system;

FIG. 3 depicts an first exemplary process flow for visualizing events;

FIG. 4 depicts an second exemplary process flow for visualizing events; and

FIG. 5 depicts an exemplary user interface for a visualization system.

### DETAILED DESCRIPTION

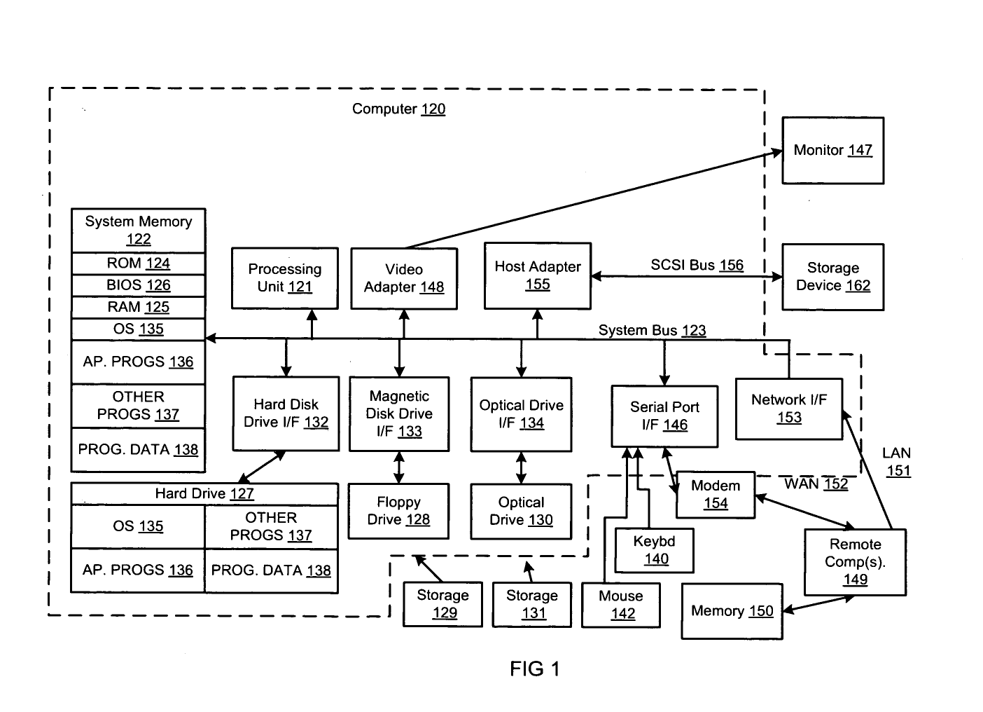

Numerous embodiments of the present invention may execute on a computer. FIG. 1 and the following discussion is intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand held devices, multi processor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read only memory (ROM) 124 and random access memory (RAM) 125. A basic input/output system 126 (BIOS), containing the basic routines that help to transfer information between elements within the personal computer 120, such as during start up, is stored in ROM 124. The personal computer 120 may further include a hard disk drive 127 for reading from and writing to a hard disk, not shown, a magnetic disk drive 128 for reading from or writing to a removable magnetic disk 129, and an optical disk drive 130 for reading from or writing to a removable optical disk 131 such as a CD ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer readable media provide non volatile storage of computer readable instructions, data structures, program modules and other data for the personal computer 120. Although the exemplary environment described herein employs a hard disk, a removable magnetic disk 129 and a removable optical disk 131, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner or the like. These and other input devices are often connected to the processing unit 121 through a serial port interface 146 that is coupled to the system bus, but may be connected by other interfaces, such as a parallel port, game port or universal serial bus (USB). A monitor 147 or other type of display device is also connected to the system bus 123 via an interface, such as a video adapter 148. In addition to the monitor 147, personal computers typically include other peripheral output devices (not shown), such as speakers and printers. The exemplary system of FIG. 1 also includes a host adapter 155, Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise wide computer networks, intranets and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used. Moreover, while it is envisioned that numerous embodiments of the present invention are particularly well-suited for computerized systems, nothing in this document is intended to limit the invention to such embodiments.

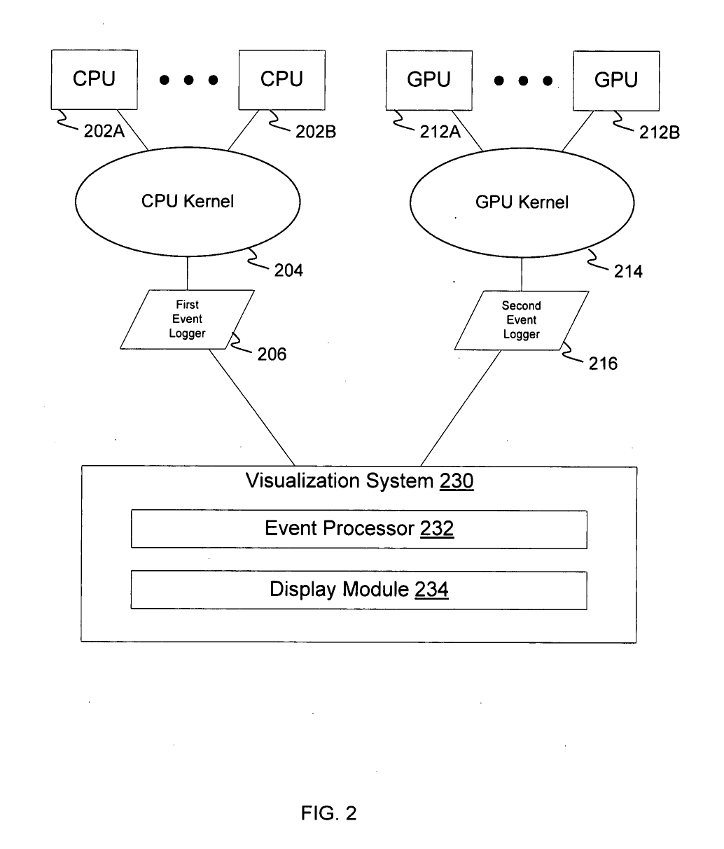

FIG. 2 depicts an exemplary visualization system 230. Within the computer 120 there may be one or more central processing units (CPU) 202A-B. The CPU 202A-B may interpret computer program extractions and a processed data. For example, the CPU 202A-B may be a microprocessor such as an x86-compatible processor.

In communication with the one or more CPUs 202A-B may be a CPU kernel 204. The CPU kernel 204 may be a component of the computer operating system 135. For example, the CPU kernel 204 may be a monolithic kernel, a microkernel, a hybrid kernel, a nanokernel, an exokernel, and the like. The CPU kernel 204 may manage system resources. The CPU kernel 204 may manage communications between hardware and software components of the computer 120. For example, it may provide an abstraction such that applications may access memory, devices, and the one or more CPUs 202A-B.

In one embodiment, the CPU kernel 204 may provide process management. For example, the CPU kernel 204 may allow computer applications to execute by allocating memory space, loading files associated with the application into memory, starting the process execution, and the like. A process may include a collection of computer executable code as being processed or run by the computer 120. The CPU kernel 204 may be a multitasking kernel such that more than one process may be managed by the CPU kernel 204 at the same time.

Each process may have one or more threads of execution. Each thread may represent a task or portion of the process that may be executed by the CPU 202A-B. For example, the thread of execution may represent a task that may be executed in parallel with another thread of execution.

The CPU kernel 204 may schedule resources for the purpose of processing the one or more threads of execution. For example, the CPU kernel 204 may include a process scheduler that manages which processes and threads may be assigned to system resources for a period of time. When a process or thread is assigned to a resource of the one or more CPUs 202A-B, a context switch may be performed. The context switch may load the CPU 202A-B with instructions associated with the process or thread being switched. After processing the thread by the CPU 202A-B, another context switch may conclude the operation.

Each operation of the CPU kernel 204 may be an event. For example, an event may associated with the creation or deletion of a process or thread. For example, an event may include disk or file input and output operations, memory faults, and system data access, and the like. Also for example, an event may include a context switch.

Events may be logged by a first event logger 206. For example, the first event logger 206 may maintain a file, memory, buffer, or the like for storing data indicative of an event that has occurred in association with the CPU kernel 204. For example, the first event logger 206 may record an event name, event type, and identifier for each event that has occurred in association with the CPU kernel 204. In one embodiment, the identifier may be a 128-bit globally unique identifier (GUID).

The first event logger 206 may record the state of the CPU kernel 204 when initiating the logging of events. In one embodiment, a circular buffer may be used to store data indicative of the event. Responsive to a trigger, the contents of the circular buffer may be written to a file, memory, or the like for future inspection. For example, the contents of the circular buffer may be inspected by the visualization system 230.

The computer 120 may also include one or more graphics processing units (GPU) 212A-B. The GPU 212A-B may be a processor adapted for rendering graphics in connection with the computer 120. The GPU 212A-B may be specifically adapted for processing the algorithms associated with video graphics. For example, the GPU 212A-B may implement one or more graphics primitive operations. The GPU 212A-B may be associated with the video adapter 148 of the computer 120. The GPU 212A-B may be mounted to a daughter card associated with the computer 120.

A GPU kernel 214 may be associated with the one or more GPUs 212A-B. The GPU kernel 214 may provide resource and process management in association with the operation of the one or more GPUs 212A-B. In one embodiment, the GPU kernel may be a software component, such as a driver or collection of drivers, that provides an interface between the graphics subsystem of computer operating system 135 and the GPU 212A-B. In one embodiment, the GPU kernel 214 may communicate with the GPU 212A-B via a kernel-mode driver. The GPU kernel 214 may provide memory management for the GPU 212A-B. The GPU kernel 214 may provide a GPU scheduler that schedules operations for processing by the GPU 212A-B.

Each operation of the GPU kernel 214 may be a GPU event. GPU events may include state changes, the beginning or end of significant operations, resource creation and deletion, and the like. GPU events may be function calls with the code that provide information or traces for performance, reliability, debugging, and the like.

GPU events may be logged by a second event logger 216. For example, the second event logger 216 may maintain a file, memory, buffer or the like for storing data indicative of a GPU event. For example, the second event logger 216 may record an event name, event type, and identifier for each GPU event that has occurred. In one embodiment, the identifier may be a 128-bit GUID. The second event logger 216 may record the state of the GPU kernel 214 when initiating the logging of events. In one embodiment, a circular buffer may be used to store data indicative of the event. Responsive to a trigger, the contents of the circular buffer may be written to a file, memory, or the like for inspection. In one embodiment, the second event logger 216 and the first event logger 206 may be implemented by the software system, subsystem, application, component, and the like.

A visualization system 230 may include an event processor 323 and a display module 234. The visualization system 230 may be a software system, subsystem, application, component, and the like. In one embodiment, the visualization system 230 may operate on the computer 120. In one embodiment, the visualization system 230 may operate on a remote computer 149 connected to the computer 120. In another embodiment, the visualization system 230 may run operate on a remote computer 149 that is not connected to the computer 120. For example, the data received from the first and second logger may be logged to a file and processed off-line and a future time. The data received from the first and second logger may be transferred to the remote computer via a removable storage medium, such as a flash drive.

The event processor 232 may receive data indicative of events occurring at a particular time and associated with a kernel. The event processor 232 may receive data indicative of event from the first event logger 206, the second event logger 216, or other source of event data. The data received from the first logger 206 may correspond to events associated with the CPU kernel 204. The data received from the second event logger 216 may correspond of events associated with the GPU kernel 214.

The data indicative of these events may include the time related to when the event occurred. For example, the data indicative of an event may include the time at which the event was recorded. Also for example the data indicative of an event may include the time that which the event occurred at the kernel. The data indicative of an event may include the event name and the identifier associated with event. For example, the data indicative of the event may include a GUID.

In one embodiment, the event processor 232 may receive kernel state information. For example, the first event logger 206 may provide state data in addition to providing data indicative of an event. The state data may include the processes currently running, memory allocation, interrupt handlers, stack and buffer contents, and the like. In one embodiment, the first event logger 206 may record a starting state data at the initiation of the logging. In another embodiment, the event processor 232 may determine the starting state. For example, where the first event logger 206 employs a circular buffer, the first event logger 206 may not record a starting state. When triggered, the first event logger 206 may record an end state. The end state and the logged events may be provided to the event processor 232, and the event processor 232 may determine the starting state from the end state and the logged events. The second event logger 216 may similarly provide state data.

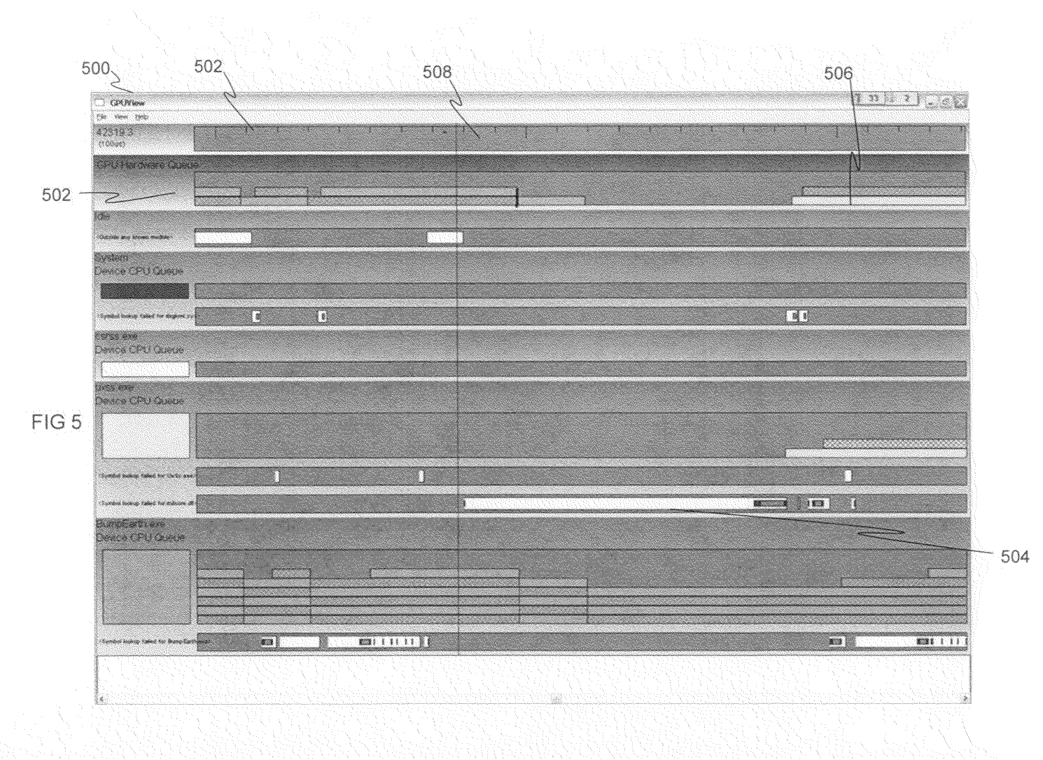

The display module 234 may process data received by the event processor 232. The display module 234 may provide a human-perceptible representation of the duration between the recorded times associated with the events. For example, the display module may provide a visual representation in the form of a timeline (see FIG. 5). The timeline may display a first representation of a first event at the CPU kernel 204. The timeline may also display a second representation of a second event at the GPU kernel 214. The relative placement of the first representation and second representation on the timeline may indicate the duration between a first time associated with the first event and a second time associated with the second event.

The visualization between CPU events and GPU events may give insight to the system-level processing associated with a graphics system and its operation with respect to the CPU 202A-B and GPU 212A-B. For example, the visualization may provide insight to a serialization of processing between the CPU kernel 204 and the GPU kernel 214. For example, a serialization of processing between the CPU kernel 204 in the GPU kernel 214 may occur where the GPU 212A-B idles, waiting for an operation of the CPU 202A-B to complete before the GPU kernel 214 may schedule another operation for processing at the GPU 212A-B. Such serializations may represent performance bottlenecks, and the display module 234 may be adapted to identify the serialization.

In one embodiment, the display module 234 may provide a human-perceptible representation of a graph (See FIG. 5). The graph may represent a queue corresponding to the GPU 212A-B. In one embodiment, the display module 234 may provide a human-perceptible representation of a vertical synchronization interval (See FIG. 5). The vertical synchronization interval may correspond to the scanning rate of the video adapter 148 and monitor 147 connected to the computer 120.

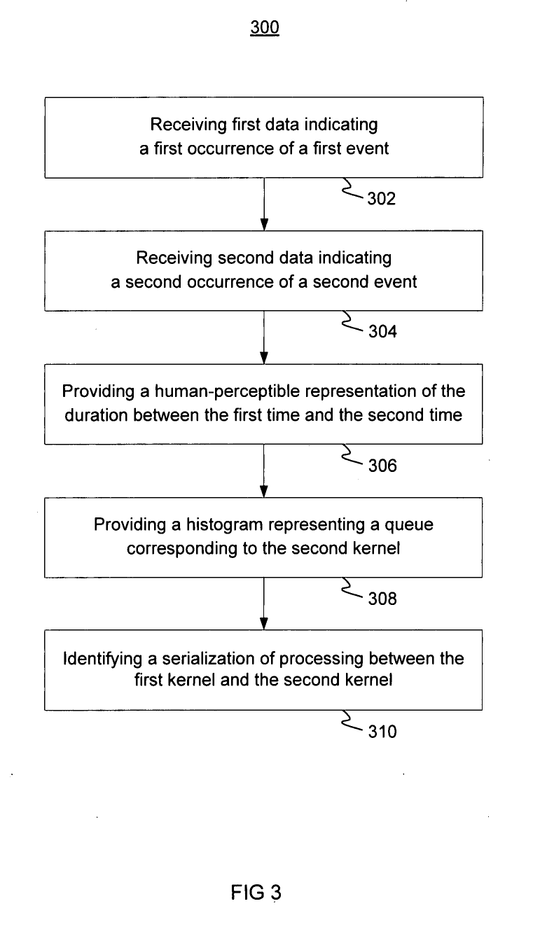

FIG. 3 depicts an exemplary process flow 300 for visualizing events. At 302, first data may be received by visualization system 230. The first data may indicate the first occurrence of a first event. The first event may be associated with a first kernel at a first time. The first kernel may correspond to a CPU.

In one embodiment, the first data may be received from a log file. In another embodiment, the first data may be received from a circular buffer in which a starting state may be determined from a recorded end state and a plurality of events. In one embodiment, the first event may record a processor operation, a memory operation, a disk operation, and the like.

At 304, second data may be received by the by visualization system 230. The second data may indicate a second occurrence of a second event at the second time. The second event may be associated with a second kernel. In one embodiment, the second kernel may correspond to a graphics processing unit.

At 306, the visualization system 230 may provide a human-perceptible representation of the duration between the first time and the second time. In one embodiment the human-perceptible representation may include a timeline on which the first and second times are indicated.

At 308, a graph may be provided. In one embodiment, the graph may represent a queue corresponding to the second kernel. For example, the graph may represent the status of a GPU queue. The GPU queue may include the collection of operations scheduled to be performed by the GPU 212A-B. In one embodiment, the GPU queue may include a workload of direct memory access (DMA) buffers. The graph may be displayed on the timeline as a function of time, such that the height of the graph at any point along the timeline may represent the number of DMA buffers in the GPU queue at that time.

In another embodiment, the graph may represent a queue corresponding to the first kernel. For example, the graph may represent the number of outstanding operations or threads to be performed by the CPU 202A-B. In one embodiment, the graph may be graphically represented by a collection of stacked rectangles.

At 310, a serialization of processing between the first kernel in the second kernel may be identified. The serialization of processing may include any inefficiency or performance bottleneck related to the interaction between the first and second kernel. For example, the serialization of processing may include an indication that the GPU 212A-B is idle waiting for a CPU 202A-B operation to complete, even though there are other processes in queue for the GPU 212A-B.

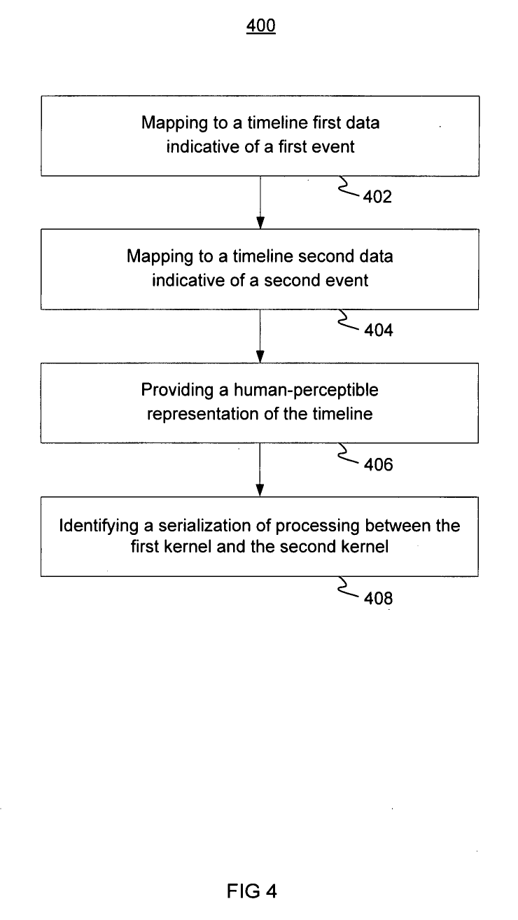

FIG. 4 depicts an exemplary process flow 400 for visualizing events. At 402, first data may be mapped to a timeline. The first data may be indicative of a first event associated with a first kernel. The first kernel may correspond to the CPU 202A-B. The first event may include a processor operation, a memory operation, a disk operation, and the like.

At 404, second data may be mapped to a timeline. The second data may be indicative of a second event associated with a second kernel. The second kernel may be correspond to a GPU 212A-B. The second event may include any operation of the second kernel.

At 406, the timeline may be provided in a human-perceptible representation. For example, the timeline may be displayed on a monitor. The timeline may include graphical representations of the first and second data. For example, the first and second data may be represented statically as a shape, color, line, and the like. Also for example, the first and second data may be represented dynamically in a window or pop-up box that is responsive to user input such as right-mouse click or by positioning the mouse over a static representation. The graphical representations of the first and second data in connection to the timeline may indicate the relative occurrences of the first and second events.

At 408, a serialization of processing between the first kernel and the second kernel may be identified. For example, the relative timing associated with the first event the second event may indicate that the first event must conclude before the second event may begin. The identification of the serialization of processing may relate to an inefficiency in the interaction between the first kernel and the second kernel. The identification of the serialization of processing may correspond to unrealized processing capacity in the computer system.

For example, the relative timing associated with the first and second events may indicate that the GPU 212A-B must delay processing operation in the GPU queue while waiting for an offending operation of the CPU 202A-B to complete. Additional processing capacity may be realized if the application or function causing the serialization were altered to allow the GPU 212A-B to process other operations while waiting for the offending operation of the CPU 202A-B to complete.

FIG. 5 depicts an exemplary user interface 500 for the visualization system 230. The user interface 500 may include a timeline 502, a representation of a first event 504, a representation of a second event 506, a representation of a vertical synchronization interval 508, and a graph 510. In one embodiment, the user interface 500 may be displayed on a computer monitor.

The timeline 502 may include a horizontal line and a time scale. Representations of events may be positioned along the timeline 502 according to respective times that each correspond to the respective event. For example, the representation of a first event 504 may be positioned to the left of the representation of a second event 506 with a respect to the timeline 502 when the first event is associated with an earlier time that the second event.

Processes that are in execution on the system may be represented by horizontal bars. The representation of a first event 504 may appear within the horizontal bar. For example, a context switch event that indicates the start of CPU operation on a thread may be indicated by the leftmost edge of a rectangle within the horizontal bar. Accordingly, a context switch event that indicates the completion of CPU operation on a thread may be indicated by the rightmost edge of a rectangle within the horizontal bar. The representation of a second event 506 may be similarly displayed. In one embodiment, events that may correspond to distinct CPUs 202A-B may be represented by different colors. In one embodiment, the horizontal bars may include thread priority.

The representation of the vertical synchronization interval 508 may include a vertical line running at periodic intervals of time. The duration between the vertical lines may correspond to the vertical refresh rate. For example, a duration 16 milliseconds may correspond to a frequency of 60 Hz. The vertical refresh rate may represent the rate at which a monitor or display device is refreshed and presented with an updated screen. Since GPU operations may be related to displayed graphics, GPU operations may prepare a screen of data to be dispatched for each vertical synchronization interval.

The graph 502 may relate to the number of operations in queue to be performed by the GPU 212A-B as a function of time. The graph may be composed by a number of stacked rectangles. Each rectangle may include a representation of a second event 506. Each stacked rectangle may indicate a range of operations.

The user interface 500 may identify a serialization of processing between the GPU 212A-B and the CPU 202A-B. For example, the representation of the second event may be preceded in time by an area corresponding to an empty GPU queue. The empty queue may be represented by a graph without a stacked rectangle. This area may be positioned to the immediate left of the representation of a second event 506 and may correspond in time to the representation of the first event 504.

For example, the representation of a first event 504 may correspond to a thread that initiates following the beginning of a new vertical synchronization interval 508. This thread may monopolize the CPU, such that no additional jobs may be attached to the GPU 212A-B. As a result the GPU 212A-B may process all of the operations in the GPU queue and may go unutilized for a period of time. Once the thread is complete, then the GPU may begin processing again, as illustrated by representation of a second event 506 corresponding in time with the completion of the thread. The representation of the second event 506 following the representation of the first event 504 may indicate a serialization occurring as a result of the process or thread corresponding to the first event. Following identification of the serialization of processing between the GPU 212A-B and CPU 202A-B, a user or developer may rewrite the application or function causing the serialization and increase overall system performance.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving first data indicating a first occurrence of a first event associated with a first kernel at a first time;
receiving second data indicating a second occurrence of a second event associated with a second kernel at a second time;
providing, based on the first data and the second data, a human-perceptible representation of the duration between the first time and the second time.

2. The method of claim 1, wherein the first kernel corresponds to a central processing unit.

3. The method of claim 2, wherein receiving first data comprises receiving the first data from a log file.

4. The method of claim 1, wherein the second kernel corresponds to a graphics processing unit.

5. The method of claim 4, further comprising providing a graph, the graph representing a queue corresponding to the second kernel.

6. The method of claim 1, wherein receiving a first kernel event comprising receiving a first kernel event from a circular buffer.

7. The method of claim 6, further comprising determining a start state from an end state and a plurality of kernel events.

8. The method of claim 1, wherein the first event records at least one of a processor operation, a memory operation, and a disk operation.

9. The method of claim 1, further wherein the human-perceptible representation comprises third data indicative of a vertical synchronization interval.

10. The method of claim 1, further comprising identifying a serialization of processing between the first kernel and the second kernel.

11. A computer readable storage medium having stored thereon computer executable instructions for performing a method comprising:
mapping to a timeline first data indicative of a first event that is associated with a first kernel;
mapping to the timeline second data indicative of a second event that is associated with a second kernel; and
providing a human-perceptible representation of the timeline.

12. The computer readable storage medium of claim 11, wherein the first kernel corresponds to a central processing unit.

13. The computer readable storage medium of claim 11, wherein the first event are stored in a log file.

14. The computer readable storage medium of claim 11, wherein the second kernel corresponds a graphics processing unit.

15. The computer readable storage medium of claim 11, wherein the first event records at least one of a processor operation, a memory operation, and a disk operation.

16. The computer readable storage medium of claim 11, further comprising identifying a serialization of processing between the first kernel and the second kernel based on the first data and the second data.

17. A visualization system comprising:
an event processor that receives a first and second data, the first data indicating a first occurrence of a first event associated with a first kernel at a first time and the second data indicating a second occurrence of a second event associated with a second kernel at a second time; and
a display module that provides, based on the first and second data, a human-perceptible representation of the duration between the first time and the second time.

18. The system of claim 17, wherein the first kernel corresponds to a central processing unit.

19. The system of claim 17, wherein the second kernel corresponds to a graphics processing unit.

20. The system of claim 17, wherein the display module is adapted to identify a serialization of processing between the first kernel and the second kernel from the timeline.
